(19) United States
(12) Patent Application Publication
(10) Pub. No.: US 2007/0038501 A1
(43) Pub. Date: Feb. 15, 2007

(54) Business solution evaluation

(75) Inventors: Juhnyoung Lee, Yorktown Heights, NY (US); Grace Y. Lin, Chappaqua, NY (US); Ko-Yang Wang, Chappaqua, NY (US); Claudia L. Woody, Atlanta, GA (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/200,847

(22) Filed: Aug. 10, 2005

(51) Int. Cl. G06Q 99/00; G07G 1/00; H04M 3/51; G06F 17/30

(52) U.S. Cl. 705/10; 705/11; 705/1

(57) ABSTRACT

An improved solution for managing a set of business solutions is provided. Each business solution includes one or more modifications to one or more business concerns for a target enterprise. A value model that comprises a value for each of the business concerns is used to determine a business value that is anticipated to be provided by each business solution. The business solutions can then be prioritized based on their business value. As a result, the invention enables business solutions to be compared based on their anticipated business value, rather than their features/functionality.

### REFERENCE TO RELATED APPLICATION

The current application is related to co-owned and co-pending U.S. patent application Ser. No. ______ (Attorney Docket No. END920050106US1), filed on Aug. 10, 2005, and entitled “Value Model”, which is hereby incorporated herein by reference.

### FIELD OF THE INVENTION

The invention relates generally to a method and system for managing business solutions, and more particularly, to a method and system that evaluate business solutions based on a corresponding business value for each business solution.

### BACKGROUND OF THE INVENTION

In today's business environment, business clients are increasingly focusing on the value provided by a particular business solution, such as an Information Technology (IT) solution. However, to date, solution providers have concentrated on identifying and explaining the features and/or functionality provided by their business solutions when promoting them. As a result, the business clients and business solutions promotions are increasingly focused on different concerns. Such a disconnect frustrates business clients and solutions promoters, lengthens the sales cycle and can result in lost sales.

International Business Machine Corp. (IBM)'s component business modeling (CBM) approach provides one solution for modeling a business. CBM is a technique for modeling an enterprise as non-overlapping business components in order to examine and analyze the enterprise to identify opportunities for innovation and improvement. A business component is a logical view of part of an enterprise that includes the resources, people, technology and know-how necessary to deliver some value (e.g., product or service). The business component can provide the value to one or more other business components/external parties and/or use the value provided by one or more other business components/external suppliers. One characteristic of a business component is that a user of its value (e.g., product or service) does not need to be aware of how the business component works, e.g., its people, processes, technology, etc. To this extent, the user only needs to know relevant properties of the service/product itself, e.g., price, agreed service level, terms and conditions, etc.

CBM can be used to generate a business component map. A business component map is a tabular view of the business components in the scope of interest. FIG. 1 shows a prior art business component map 2 that can be generated using CBM. Business component map 2 includes multiple columns, each of which represents a business competency (e.g., a large business area with characteristic skills and capabilities), and multiple rows that each define an accountability level, which characterizes the scope of decision making. In CBM, three accountability levels can be used; direct, which includes strategy, overall direction and policy; control, with includes monitoring, managing exceptions and tactical decision making; and execute, which includes actually performing the work. Each row/column combination includes one or more business components. Generally, a business component is only within one cell of business component map 2.

A business component can also be characterized by associating it with a set of business activities. A business activity is simply something the enterprise does, specified at a level that the enterprise considers to be appropriate. Business activities can also be mapped into business component map 2. To this extent, one solution for identifying business components includes allocating business activities into the corresponding cells in business component map 2 and grouping the business activities in each cell into one or more business components.

In general, a business component model includes the business competencies, business components, business services and the corresponding relationships that describe a particular enterprise or industry. To this extent, there are several types of business component models: an enterprise component model describes a particular enterprise; an industry component model describes a generic enterprise in an industry; a universal component model describes a generic cross-industry enterprise; and an industry ecosystem component model describes an entire industry.

However, CBM's usefulness in evaluating a proposed business solution is limited. For example, CBM does not include a mechanism to obtain a business value for the proposed business solution. To this extent, a need exists for an improved solution for evaluating business solutions that addresses these needs and/or other needs not expressly discussed herein.

### SUMMARY OF THE INVENTION

The invention provides an improved solution for managing a set of business solutions. In one embodiment, a business pain point is obtained for a target enterprise and one or more business solutions are generated based on the business pain point and a business model for the target enterprise. Regardless, each business solution includes one or more modifications to one or more business concerns for the target enterprise. A value model that comprises a value for each of the business concerns is used to determine a business value that is anticipated to be provided by each business solution. The business solutions can then be prioritized based on their business values. The business solutions can be reviewed and compared, and one or more can be selected for implementation. After implementation, the actual business value can be measured and if necessary, one or more adjustments to the value model can be made. As a result, the invention enables business solutions to be compared based on their anticipated business value, rather than their features/functionality. Further, the invention can provide a closed loop solution for identifying, deploying and evaluating business solutions, improving the accuracy of future evaluations, as well as providing a base for improving the future design of the business solution.

A first aspect of the invention provides a method of evaluating a set of business solutions, the method comprising: obtaining the set of business solutions, wherein each of the set of business solutions comprises at least one modification to a set of business concerns for a target enterprise; obtaining a value model that comprises a value for each of the set of business concerns; and determining a business value for each of the set of business solutions based on the value model.

A second aspect of the invention provides a system for evaluating a set of business solutions, the system comprising: a system for obtaining the set of business solutions, wherein each of the set of business solutions comprises at least one modification to a set of business concerns for a target enterprise; a system for obtaining a value model that comprises a value for each of the set of business concerns; and a system for determining a business value for each of the set of business solutions based on the value model.

A third aspect of the invention provides a program product stored on a computer-readable medium, which when executed, enables a computer infrastructure to evaluate a set of business solutions, the program product comprising computer program code for enabling the computer infrastructure to perform the steps of: obtaining the set of business solutions, wherein each of the set of business solutions comprises at least one modification to a set of business concerns for a target enterprise; obtaining a value model that comprises a value for each of the set of business concerns; and determining a business value for each of the set of business solutions based on the value model.

A fourth aspect of the invention provides a method of managing a set of business solutions, the method comprising: obtaining a business pain point for a target enterprise; obtaining a business model for the target enterprise, wherein the business model includes a set of business concerns; obtaining a value model that comprises a value for each of the set of business concerns; identifying a set of target business concerns associated with the business pain point based on the business model; identifying a set of shortfalls in the set of target business concerns; generating the set of business solutions to address the set of shortfalls; and determining a business value for each of the set of business solutions based on the value model.

A fifth aspect of the invention provides a system for managing a set of business solutions, the system comprising: a system for obtaining a business pain point for a target enterprise; a system for obtaining a business model for the target enterprise, wherein the business model includes a set of business concerns; a system for obtaining a value model that comprises a value for each of the set of business concerns; a system for identifying a set of target business concerns associated with the business pain point based on the business model; a system for identifying a set of shortfalls in the set of target business concerns; a system for generating the set of business solutions to address the set of shortfalls; and a system for determining a business value for each of the set of business solutions based on the value model.

A sixth aspect of the invention provides a program product stored on a computer-readable medium, which when executed, enables a computer infrastructure to manage a set of business solutions, the program product comprising computer program code for enabling the computer infrastructure to perform the steps of: obtaining a business pain point for a target enterprise; obtaining a business model for the target enterprise, wherein the business model includes a set of business concerns; obtaining a value model that comprises a value for each of the set of business concerns; identifying a set of target business concerns associated with the business pain point based on the business model; identifying a set of shortfalls in the set of target business concerns; generating the set of business solutions to address the set of shortfalls; and determining a business value for each of the set of business solutions based on the value model.

A seventh aspect of the invention provides a business method for managing a set of business solutions, the business method comprising managing a computer infrastructure that performs one or more of the steps of the invention; and receiving payment based on the managing step.

An eighth aspect of the invention provides a method of generating a system for evaluating a set of business solutions, the method comprising: providing a computer infrastructure operable to: obtain the set of business solutions, wherein each of the set of business solutions comprises at least one modification to a set of business concerns for a target enterprise; obtain a value model that comprises a value for each of the set of business concerns; and determine a business value for each of the set of business solutions based on the value model.

A ninth aspect of the invention provides a method of generating a system for managing a set of business solutions, the method comprising: providing a computer infrastructure operable to: obtain a business pain point for a target enterprise; obtain a business model for the target enterprise, wherein the business model includes a set of business concerns; obtain a value model that comprises a value for each of the set of business concerns; identify a set of target business concerns associated with the business pain point based on the business model; identify a set of shortfalls in the set of target business concerns; generate the set of business solutions to address the set of shortfalls; and determine a business value for each of the set of business solutions based on the value model.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a prior art business component map.

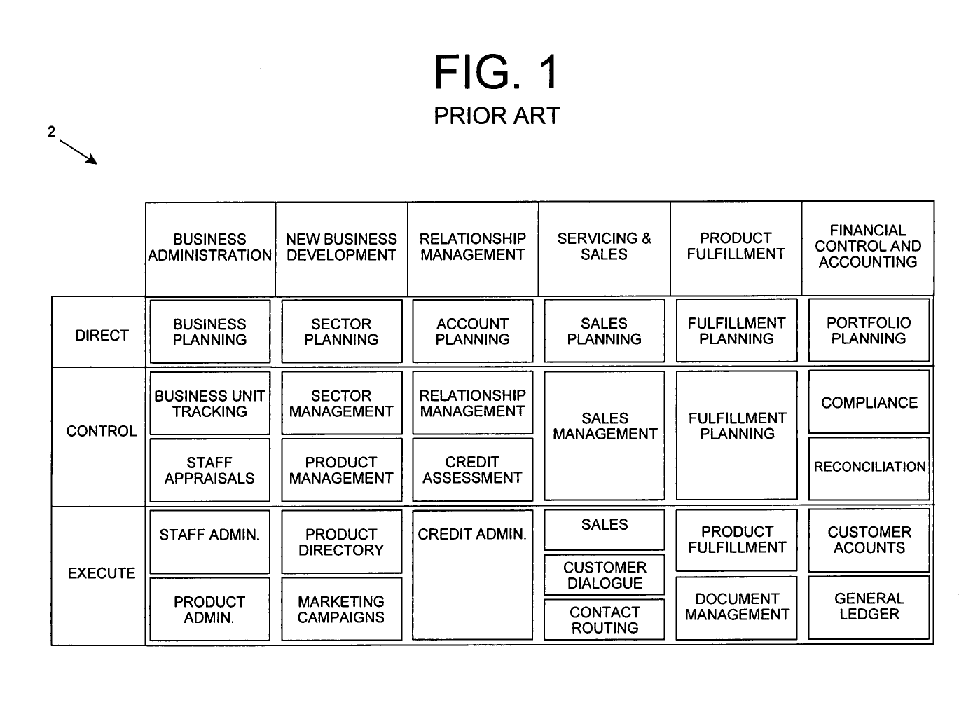

FIG. 2 shows an illustrative environment for managing a set (one or more) of business solutions according to one embodiment of the invention.

FIG. 3 shows illustrative method steps for managing the set of business solutions according to another embodiment of the invention.

FIG. 4 shows additional illustrative method steps for managing the set of business solutions according to still another embodiment of the invention.

FIG. 5 shows additional illustrative method steps for managing the set of business solutions according to yet another embodiment of the invention.

FIG. 6 shows an illustrative model-driven business transformation model.

FIG. 7 shows an illustrative component business model metamodel.

FIG. 8 shows an illustrative business component map that is annotated with relationship data between various business components.

FIG. 9 shows an illustrative heat map that includes evaluation criteria for two value drivers.

FIG. 10 shows an illustrative overlay of IT components on a business component map.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the invention provides an improved solution for managing a set of business solutions. In one embodiment, a business pain point is obtained for a target enterprise and one or more business solutions are generated based on the business pain point and a business model for the target enterprise. Regardless, each business solution includes one or more modifications to one or more business concerns for the target enterprise. A value model that comprises a value for each of the business concerns is used to determine a business value that is anticipated to be provided by each business solution. The business solutions can then be prioritized based on their business values. The business solutions can be reviewed and compared, and one or more can be selected for implementation. After implementation, the actual business value can be measured and if necessary, one or more adjustments to the value model can be made. As a result, the invention enables business solutions to be compared based on their anticipated business value, rather than their features/functionality. Further, the invention can provide a closed loop solution for identifying, deploying and evaluating business solutions, improving the accuracy of future evaluations, as well as providing a base for improving the future design of the business solution.

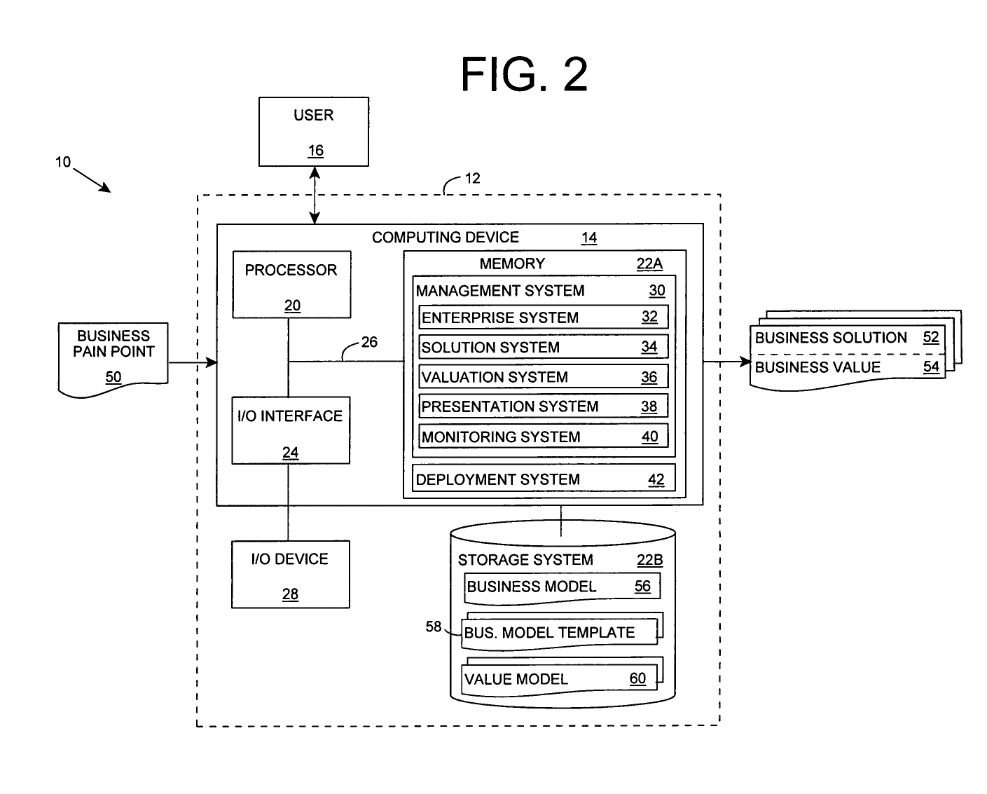

Turning to the drawings, FIG. 2 shows an illustrative environment 10 for managing a set (one or more) of business solutions 52. To this extent, environment 10 includes a computer infrastructure 12 that can perform the various process steps described herein for managing the set of business solutions 52. In particular, computer infrastructure 12 is shown including a computing device 14 that comprises a management system 30, which enables computing device 14 to manage the set of business solutions 52 by performing some or all of the process steps described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as management system 30, that is stored in memory 22A and/or storage system 22B. While executing computer program code, processor 20 can read and/or write data, such as a business model template 58, to/from memory 22A, storage system 22B, and/or I/O interface 24. Bus 26 provides a communications link between each of the components in computing device 14. I/O device 28 can comprise any device that enables user 16 to interact with computing device 14 or any device that enables computing device 14 to communicate with one or more other computing devices.

In any event, computing device 14 can comprise any general purpose computing article of manufacture capable of executing computer program code installed by a user 16 (e.g., a personal computer, server, handheld device, etc.). However, it is understood that computing device 14 and management system 30 are only representative of various possible equivalent computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques. Further, user 16 can utilize another computing device (not shown) in communication with computer infrastructure 12 over any type of communications link, such as the Internet, to manage business solution(s) 52 using management system 30.

As previously mentioned and discussed further below, management system 30 enables computing infrastructure 12 to manage business solution(s) 52. To this extent, management system 30 is shown including an enterprise system 32, a solution system 34, a valuation system 36, a presentation system 38, and a monitoring system 40. Operation of each of these systems is discussed further below. However, it is understood that some of the various systems shown in FIG. 2 can be implemented independently, combined, and/or stored in memory for one or more separate computing devices that are included in computer infrastructure 12. Further, it is understood that some of the systems and/or functionality may not be implemented, or additional systems and/or functionality may be included as part of environment 10 and/or management system 30.

Regardless, the invention provides a solution for managing business solution(s) 52. In one embodiment, the invention provides a solution for evaluating a set of business solutions 52 based on a business value 54 that corresponds to each business solution 52. In particular, each business solution 52 can be generated in response to one or more business pain points 50 for a target enterprise. A business pain point 50 can comprise any business area that the target enterprise seeks to implement and/or improve. For example, business pain point 50 can comprise a business problem, a goal of increasing value (e.g., shareholder value), a goal of improving profitability, a new business area/solution, and the like. The target enterprise can comprise any type of entity including, for example, a government agency, a private/public business, an educational entity, etc. To this extent, the target enterprise can conduct any type of business or operation.

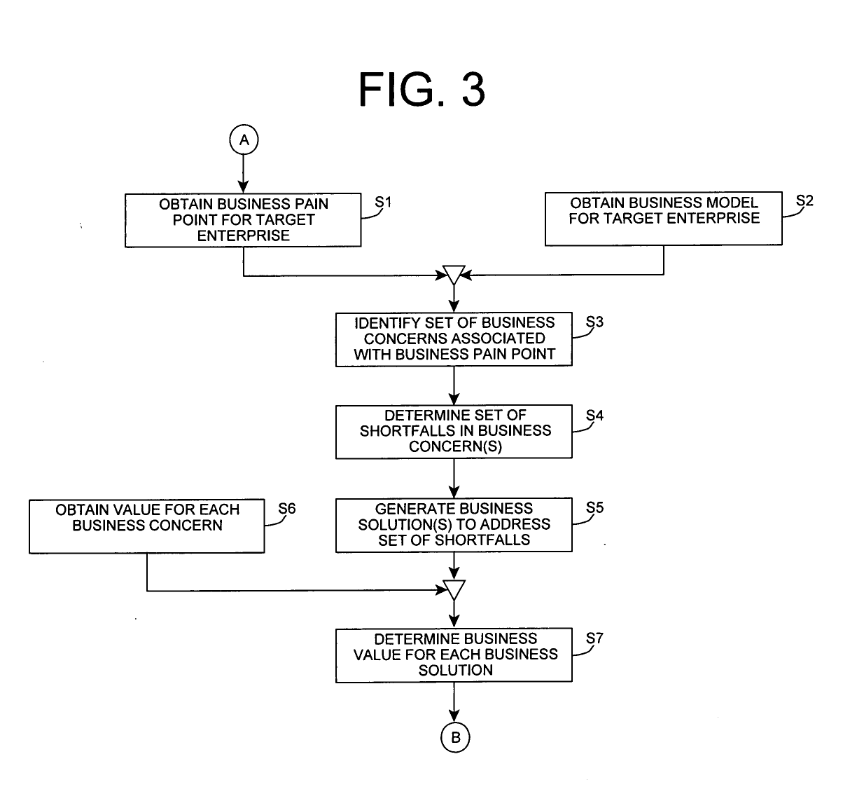

In any event, FIG. 3 shows illustrative method steps for managing business solution(s) 52 according to one embodiment of the invention, which can be implemented by the various systems shown within management system 30 (FIG. 2). Referring to both FIGS. 2 and 3, enterprise system 32 can obtain information on a particular target enterprise. In particular, in step S1 of FIG. 3, enterprise system 32 can receive one or more business pain points 50 for the target enterprise. Enterprise system 32 can obtain the business pain point(s) 50 using any known solution. For example, enterprise system 32 can generate a user interface for display to user 16, which enables user 16 to specify one or more business pain points 50. To this extent, business pain points 50 can be selected from a plurality of predefined business pain points 50 in a structured manner, e.g., by a series of menu options, or the like. Alternatively, one or more business pain points 50 can be communicated to enterprise system 32 from another system (e.g., a customer definition system).

In step S2, enterprise system 32 can obtain a business model 56 for the target enterprise. Business model 56 comprises any type of representation of the operations performed by the target enterprise. To this extent, business model 56 can include a set of business concerns for the target enterprise. A business concern comprises any type of element used to represent some aspect of the target enterprise. For example, a business concern can comprise an element that represents a business process, a business activity, a business component, a resource, or the like. Further, a business concern can comprise an element that represents a relationship between two or more other business concerns. In one embodiment, business model 56 is developed using IBM's component business modeling (CBM) approach. However, it is understood that this is only illustrative, and any type of business model 56 can be used.

Enterprise system 32 can obtain business model 56 from another system and/or can enable a user 16 to create and/or edit the business model 56. In the latter case, enterprise system 32 can obtain business model 56 by first obtaining business information for the target enterprise, and then building business model 56 in a machine understandable language (e.g., extensible markup language) to facilitate further processing of business model 56. To this extent, enterprise system 32 can enable user 16 to select one of a plurality of business model templates 58 from which business model 56 can be generated. For example, each business model template 58 can comprise a default business model for a particular type of business (e.g., insurance, banking, etc.). When few details are known about the target enterprise, user 16 can use enterprise system 32 to select a business model template 58 based on the type of business of the target enterprise, and the business model template 58 can be used as the business model 56 for the target enterprise. Subsequently, user 16 can use enterprise system 32 to adjust the business model template 58 based on feedback from the target enterprise. For example, user 16 can discuss the various business concerns of the target enterprise and make any corresponding adjustments to business model template 58. In this manner, user 16 can use enterprise system 32 to generate a business model 56 that accurately represents the particular target enterprise.

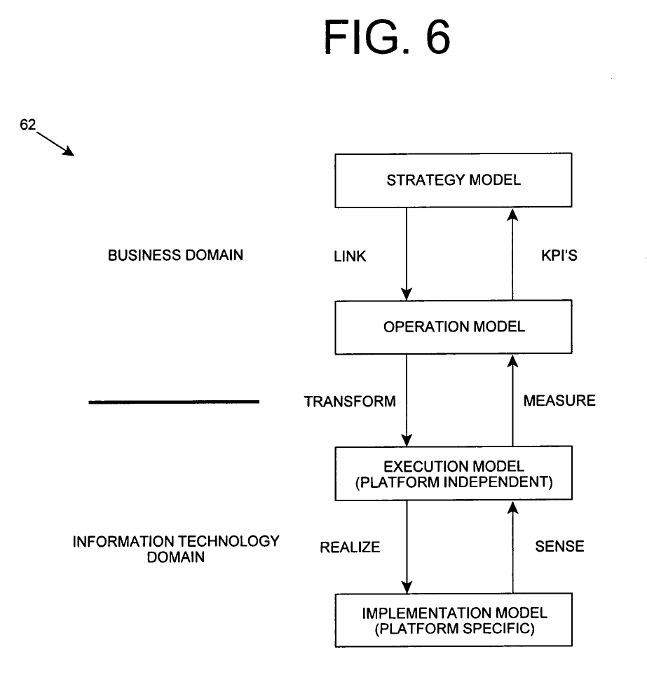

In one embodiment, enterprise system 32 generates business model 56 using an expansion of IBM's CBM approach. To this extent, enterprise system 32 can merge and extend aspects of both CBM and model-driven business transformation (MDBT) approaches to generate a business model 56 that can be used to identify related business components and be utilized in a value-driven business transformation. MDBT provides a multi-layer model that links business semantics with enterprise infrastructure, such as an information technology (IT) architecture, semantics. FIG. 6 shows an illustrative multi-layer MDBT model 62. As shown, the upper layers of the model represent business semantics in terms familiar to business executives, business managers and analysts, such as key performance indicators, operational metrics, business processes, activities and governance. The lower layers of the model represent IT architecture comprising a wide range of services implemented in IT infrastructure such as service-oriented architecture. The vision of this multi-layer model is to enable IT solutions to accurately reflect and be driven by business intent. This approach is different from the typical technology-oriented business integration, because it provides a top-down business perspective which enforces a business-orientation for business transformation. Further, an IT solution generated by this approach should accurately and precisely reflect the original business semantics and be directly deployable and executable thereby achieving maintainable alignment between business design and IT solutions.

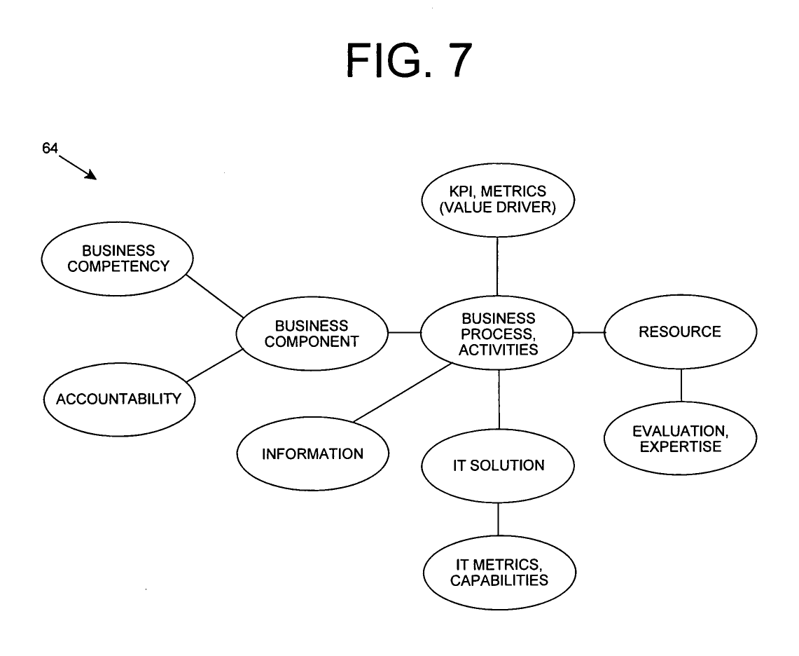

To this extent, enterprise system 32 can define an enhanced CBM metamodel that captures the benefits of both the CBM and MDBT approaches. For example, FIG. 7 shows an illustrative CBM metamodel 64 according to one embodiment of the invention. CBM metamodel 64 defines a composite class that provides the structure of business model 56 (FIG. 2). The composite class includes a class for each of metrics (e.g., value drivers, key performance indicators (KPIs)), business processes/activities, resources (e.g., organization hierarchy, social network), IT solution, information, and business components. Further, each class corresponds to a layer in the MDBT model 62 (FIG. 6). In particular, the strategy layer corresponds to metrics, the operation layer corresponds to processes/activities and business components, the execution layer corresponds to platform-independent portions of the IT solutions, and the implementation layer corresponds to platform dependent portions of the IT solutions. Instance data for each class is known to individuals at the corresponding part of the enterprise (e.g, IT solution data is known to the IT department). To this extent, enterprise system 32 can provide facilities to manage this instance data, e.g., import information, map information to each CBM metamodel class, display each class with instance data, etc. As a result, enterprise system 32 can generate a semantic business model 56 (FIG. 2) that associates KPIs with activities and activities with components, thereby enabling capturing a relationship between KPIs in the semantic business model 56 and automatically inferring the dependencies between components.

Returning to FIGS. 2 and 3, in step S3, solution system 34 can obtain a set (one or more) of target business concerns that are associated with business pain point 50. In one embodiment, solution system 34 can automatically identify the set of target business concerns based on business model 56. In this case, solution system 34 can identify at least one business concern that directly impacts business pain point 50. Subsequently, solution system 34 can use relationship information in business model 56 for the identified business concern(s) to identify other business concerns that may impact business pain point 50. Additionally, user 16 can use an interface generated by solution system 34 to identify the set of target business concerns and/or add/remove business concerns to the set of target business concerns. Still further, solution system 34 can receive the set of target business concerns from another system.

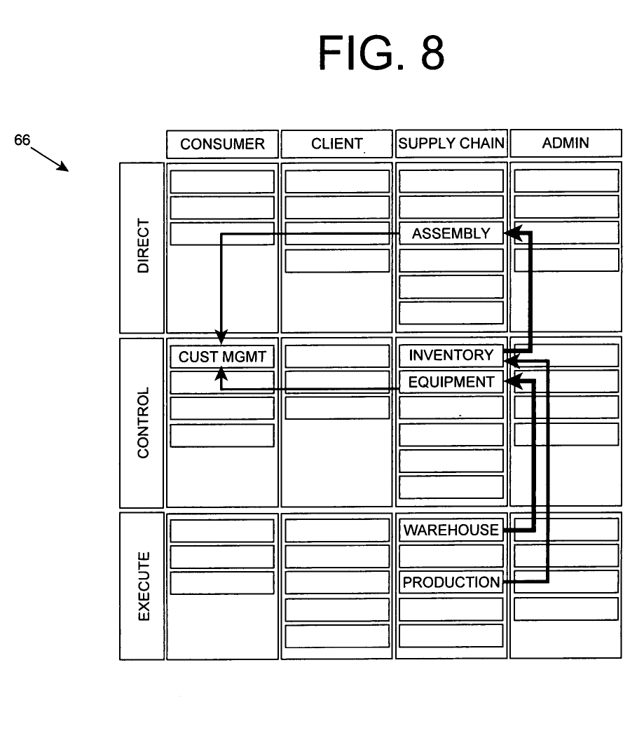

In this manner, solution system 34 can use simple semantic queries, derive values of a component from the values of entities associated with the component, and so enable root-cause or impact analysis, and extend the analysis to a larger set of value drivers and/or KPIs. Further, solution system 34 can generate one or more displays that depict information on business pain point 50 and/or the various business concerns. For example, FIG. 8 shows an illustrative business component map 66 that is annotated with relationship data between various business components. In this case, solution system 34 can determine each business concern that directly impacts business pain point 50 and subsequently use relationship data, such as that defined by CBM metamodel 64 (FIG. 6) to identify all the related business concerns. Further, solution system 34 can generate a display for business component map 66. As shown, an amount of dependency between two business concerns can be indicated by a thickness of the arrow. However, it is understood that any solution can be used, such as altering a color in which each business concern is displayed. Similarly, an amount that a business concern is related to the business pain point 50 can be displayed on business component map 66 in a similar fashion.

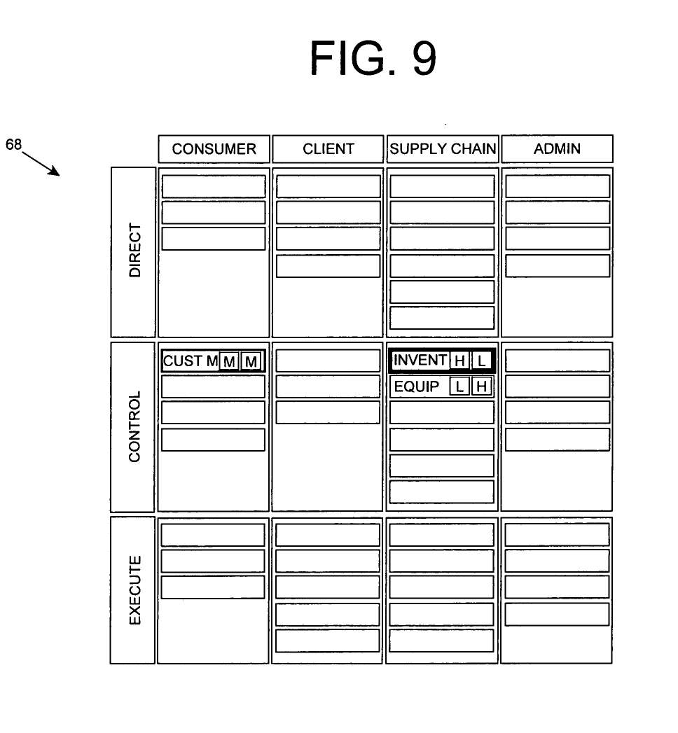

Additionally, solution system 34 can generate a heat map that comprises a business component map annotated with evaluation information. To this extent, FIG. 9 shows an illustrative heat map 68 that includes evaluation criteria for two value drivers. In particular, heat map 68 includes the results of an evaluation of the two value drivers in boxes displayed in the corresponding business concerns. The results can be categorized as high (H), medium (M) or low (L). Solutions system 34 can further evaluate the results based on the corresponding value driver. For example, assuming the left box displayed in each business concern indicates cost while the right box indicates satisfaction, solution system 34 can highlight for improvement a business concern that has high cost and low satisfaction. As shown, varying gradations can be used to designate an amount of potential improvement required for each business concern. It is understood that various solutions for highlighting business concerns can be used. For example, solutions system 34 can color business concerns green for no improvement needed, red for substantial improvement needed, and various intermediate colors for other improvement requirements.

In any event, returning to FIGS. 2 and 3, in step S4, solution system 34 can obtain a set (one or more) of shortfalls in the set of target business concerns. In one embodiment, solution system 34 can identify the set of shortfalls based on one or more recommended attributes, such as a best practice, an industry standard, a benchmark, prior implementation data, and/or the like. In this case, solution system 34 can determine one or more attributes of each target business concern and compare it to the recommended attribute. When the target business concern's attribute indicates too few resources, a corresponding shortfall can be identified.

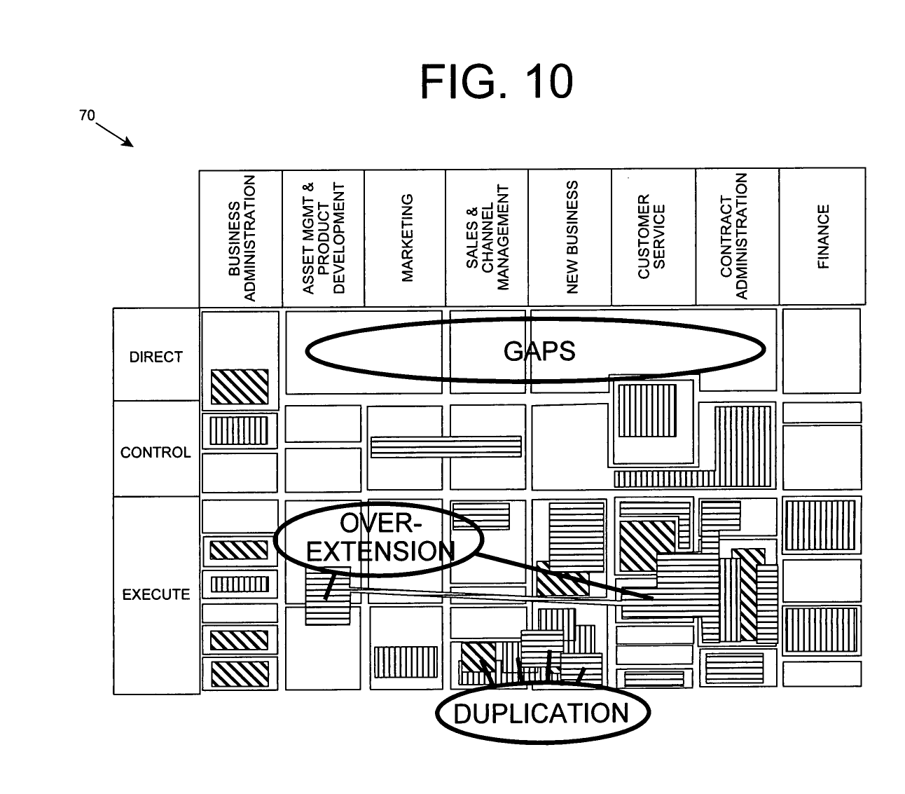

In one embodiment, solution system 34 can generate an overlay of one or more components of an enterprise infrastructures, such as an IT architecture, with the business component map. For example, FIG. 10 shows an illustrative overlay 70 of IT components on a business component map. As shown, each IT component is treated as a business asset, and the overlay 70 shows which business concern “owns” (e.g., uses) which IT component. In this manner, the systems coverage can be readily determined and any shortfalls can be identified. Such an overlay 70 can be used to assess various types of shortfalls in an enterprise. For example, a “gap” appears when no IT component exists for a particular business concern. In this case, the system lacks key functionality or reflects a poor design by using the wrong technology for a particular component. Similarly, “duplication” occurs when multiple IT components are utilized for the same business concern, typically adding unnecessary complexity and/or cost to development, maintenance and production. Further, “over-extension” occurs when a system designed to support one business concern is extended to help support others, for which it may not have the appropriate capabilities. Additionally, as a system gets more diverse/extensive use, the cost and/or complexity of its operation can increase substantially.

Returning to FIGS. 2 and 3, in step S5, solution system 34 can generate a set (one or more) of business solutions 52 based on the business pain point 50. In particular, each business solution 52 can comprise at least one modification to one or more business concerns in business model 56. The modification(s) can be selected to address one or more of the shortfalls that correspond to the business pain point 50. A modification can comprise an increase in one or more attributes of a business concern, the addition of a business concern, and/or the like. In general, for a particular shortfall or group of shortfalls, there may be more than one business solution 52. In this case, solution system 34 can generate multiple business solutions 52 that address the same shortfall(s). Additionally, solution system 34 can generate one or more business solutions 52 that partially address the shortfall(s) by, for example, only partially addressing a particular shortfall and/or not addressing one or more shortfalls. In any event, solution system 34 can automatically generate the set of business solutions 52 and/or user 16 can use solution system 34 to generate and/or modify one or more of the set of business solutions 52.

In this manner, the invention can include a model-driven business transformation solution. In particular, business transformation (e.g., business solution(s) 52) is generated based on a business model 56 for the target enterprise and/or recommended processes. It is understood that the invention can be implemented independent of the generation of business solution(s) 52. To this extent, solution system 34 can obtain the set of business solutions 52 from another system that generates and/or modifies the business solution(s) 52 using any solution.

One embodiment of the invention provides a value-driven evaluation of the set of business solutions 52. To this extent, in step S6, valuation system 36 can obtain a value model 60 that comprises a value for each business concern in business model 56. Valuation system 36 can generate and/or modify value model 60 and/or obtain value model 60 from another system that manages value model(s) 60. In any event, value model 60 can comprise any type of model that assigns a value to a particular business concern. For example, value model 60 can assign the value as a relative percentage increase/decrease to the value obtained by the business concern when one or more attributes are increased/decreased. Further, value model 60 can include relationship information for the various business concerns. The relationship information can define a percentage contribution, or the like, that one business concern provides for another business concern. Additional information, such as an error margin, high/low value range, or the like, can also be included in value model 60. In one embodiment, value model 60 is generated as described in the co-owned and co-pending U.S. patent application Ser. No. ______ (Attorney Docket No. END920050106US1), filed on Aug. 10, 2005, and entitled “Value Model”, which is hereby incorporated herein by reference. However, it is understood that this is only illustrative and any value model 60 can be used.

In step S7, valuation system 36 can determine a business value 54 for each business solution 52 based on value model 60. In particular, for each modification to a business concern included in a business solution 52, value model 60 can be used to determine a value that the modification will yield. Subsequently, the values can be combined to determine the business value for the business solution 52. It is understood that value model 60 can include aggregate information on one or more combinations of modifications. In this case, when combining values, the aggregate information can be used to determine the combined value of the modifications (e.g., a synergistic/cannibalistic effect). In any event, the values can be combined (e.g., summed or using another mathematical model) to yield the business value 54 for business solution 52.

As a result, the invention provides a solution for evaluating business solution(s) 52 based on the business value 54 that each business solution 52 will provide to the target enterprise. Using this information, the target enterprise can make various decisions on how/when/if to implement the business solution(s) 52. To this extent, valuation system 36 can be implemented as part of a larger system that manages various additional aspects of business solutions 52.

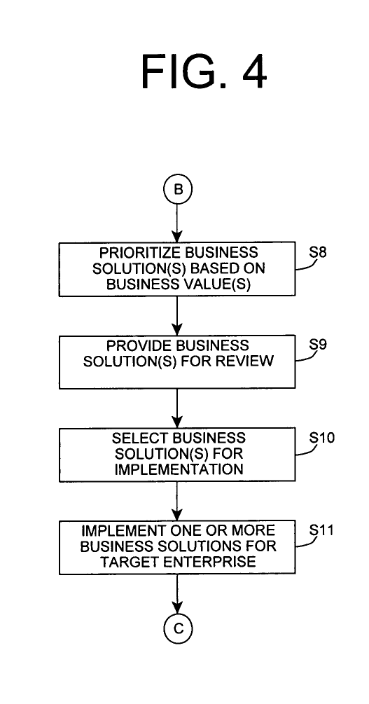

For example, FIG. 4 shows additional illustrative method steps for managing the set of business solutions 52, which can be implemented by the various systems shown within management system 30 (FIG. 2). Referring to both FIGS. 2 and 4, after determining business value(s) 54 in step S7 (FIG. 3), flow can proceed to step S8 of FIG. 4. In step S8, presentation system 38 can prioritize the set of business solutions 52 based on their corresponding business values 54. For example, the business solution(s) 52 can be ordered from the highest business value 54 to the lowest business value 54. Further, presentation system 38 can use additional factors to prioritize business solutions 52. For example, presentation system 38 can incorporate a cost factor, a time factor, a flexibility provided, a resource usage rate, and/or the like, to prioritize the business solution(s) 52.

In step S9, presentation system 38 can provide the set of business solutions 52 for review by, for example, user 16. For example, presentation system 38 can generate an interface that displays and/or compares the set of business solutions 52 and the corresponding business value 54 of each. Further, additional information, such as the cost/time to implement, etc., can also be displayed. User 16 can comprise any individual interested in and having permission to view the set of business solutions 52. For example, user 16 could comprise an information technology (IT) officer that is seeking business solutions 52 to improve the IT infrastructure for the target enterprise. Similarly, user 16 could comprise a service provider that is performing an external audit of the target enterprise to identify key areas for improvement.

Regardless, in step S10, user 16 can use presentation system 38 to select one or more of the business solution(s) 52 for implementation. In particular, user 16 can input his/her selection(s) into the interface described above, which can subsequently be received and processed by presentation system 38. In one embodiment, presentation system 38 can provide the selection(s) to a deployment system 42. Deployment system 42 can perform the required scheduling, ordering, etc., that will be required in order to implement the business solution(s) 52. In step S11, deployment system 42 can implement the business solution(s) 52 for the target enterprise.

In one embodiment, the invention provides an improved solution for performing “needs” identification and solution delivery within a portion (e.g., an IT infrastructure) of a target enterprise. To this extent, a service provider can perform steps S1-S9 as part of the needs identification. As noted above, needs identification can comprise the identification and translation of business pain point(s) 50 into one or more possible business solutions 52. Further, a business value 54 can be determined for each business solution 52. Subsequently, the service provider and/or another solution provider can perform steps S10-S11 as part of the solution delivery portion. In particular, one or more business solutions 52 can be selected, e.g., with the assistance of the corresponding business values 54, and can be implemented for the target enterprise.

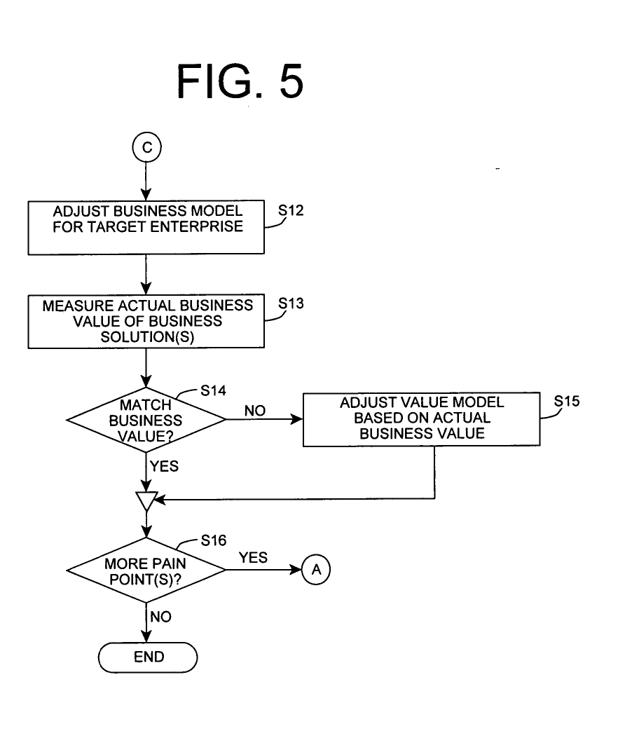

Further, the invention can include monitoring business solution(s) 52 after implementation for a target enterprise. FIG. 5 shows additional illustrative method steps for managing business solution(s) 52 (FIG. 2), which can be implemented by the various systems shown within management system 30 (FIG. 2). Referring to FIGS. 2 and 5, after one or more business solutions 52 are selected to be implemented in step S10 (FIG. 4) and/or are implemented in step S11 (FIG. 4), in step S12, enterprise system 32 can adjust business model 56 based on the selected/implemented business solution(s) 52. In particular, presentation system 38 can provide data on the selected business solution(s) 52 to enterprise system 32 and/or deployment system 42 can provide data on the implemented business solution(s) 52 to enterprise system 32. In either case, enterprise system 32 can adjust business model 56 so that it includes the selected/implemented business solution(s) 52.

In step S13, as the target enterprise uses the business solution(s) 52, monitoring system 40 can measure an actual business value of the implemented business solution(s) 52 for the target enterprise. The actual business value can be measured by one or more of various types of metrics. For example, for an IT business solution 52, monitoring system 40 can obtain data on the performance of one or more business concerns that were impacted (e.g., implemented, improved, or the like) by the business solution 52. Similarly, monitoring system 40 can obtain higher level data, such as an impact on profitability, costs, customer satisfaction, etc., for the target enterprise.

In any event, in step S14, monitoring system 40 can compare the actual business value to the predicted business value 54 for the business solution 52 to determine an accuracy of the predicted business value 54. When business value 54 does not match (e.g., is outside of an error margin) the actual business value, then in step S15, valuation system 36 can adjust value model 60 based on the measured actual business value. For example, valuation system 36 can adjust the values for one or more business concerns in value model 60, can adjust relationships between two or more business concerns, etc. Valuation system 36 can make the adjustments to a value model 60 for the particular target enterprise and/or to a standard value model 60 that is used by default for other target enterprises.

Regardless, in step S16, monitoring system 40 can determine if one or more additional business pain points 50 are present for the target enterprise. For example, an implemented business solution 52 may have provided less than the predicted business value 54 resulting in a continued business need. Alternatively, the target enterprise may desire to expand into another area. In any event, if an additional business pain point 50 is present, then flow can return to step S1 (FIG. 3) and new business solution(s) 52 can be generated, prioritized, and/or implemented as discussed herein. When no additional business pain point 50 is present, the process can terminate.

In one embodiment, the need identification, solution delivery and monitoring phases are performed in a closed loop. In this case, monitoring system 40 can obtain data on various performance characteristics of the target enterprise (e.g., the IT infrastructure), and automatically identify one or more business pain points 50. Once identified, monitoring system 40 can provide the business pain points 50 to enterprise system 32 and flow can continue at step S1 (FIG. 3) in the need identification portion of the closed loop.

While shown and described herein as a method and system for evaluating and/or managing a set of business solutions 52, it is understood that the invention further provides various alternative embodiments. For example, in one embodiment, the invention provides a computer-readable medium that includes computer program code to enable a computer infrastructure to evaluate and/or manage the set of business solutions 52. To this extent, the computer-readable medium includes program code, such as management system 30 (FIG. 2), that implements one or more of the various process steps discussed herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 2) and/or storage system 22B (FIG. 2) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs some or all of the process steps described herein on a subscription, advertising, and/or fee basis. That is, a service provider, such as an Application Service Provider, could offer to evaluate and/or manage the set of business solutions 52 (FIG. 2) as described above. In this case, the service provider can manage (e.g., create, maintain, support, etc.) a computer infrastructure, such as computer infrastructure 12 (FIG. 2), that performs some or all of the process steps described herein for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for evaluating and/or managing the set of business solutions 52 (FIG. 2). In this case, a computer infrastructure, such as computer infrastructure 12 (FIG. 2), can be provided (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of evaluating a set of business solutions, the method comprising:
obtaining the set of business solutions, wherein each of the set of business solutions comprises at least one modification to a set of business concerns for a target enterprise;
obtaining a value model that comprises a value for each of the set of business concerns; and
determining a business value for each of the set of business solutions based on the value model.

2. The method of claim 1, further comprising:
prioritizing the set of business solutions based on their corresponding business values; and
providing the set of business solutions for review.

3. The method of claim 1, further comprising selecting at least one of the set of business solutions for implementation.

4. The method of claim 1, further comprising implementing at least one of the set of business solutions for the target enterprise.

5. The method of claim 4, further comprising measuring an actual business value of the implemented at least one of the set of business solutions for the target enterprise.

6. The method of claim 5, further comprising adjusting the value model based on the measured actual business value.

7. The method of claim 1, further comprising obtaining a business model for the target enterprise, wherein the business model includes the set of business concerns.

8. The method of claim 7, wherein the obtaining a set of business solutions step includes:
obtaining a business pain point for the target enterprise; and
generating the set of business solutions based on the business pain point and the business model.

9. The method of claim 8, wherein the generating step includes:
obtaining a set of target business concerns associated with the business pain point;
obtaining a set of shortfalls in the set of target business concerns; and
generating the set of business solutions to address the set of shortfalls.

10. The method of claim 7, wherein the obtaining a business model step includes:
selecting a business model template based on a type of business; and
adjusting the business model template based on feedback from the target enterprise.

11. A program product stored on a computer-readable medium, which when executed, enables a computer infrastructure to evaluate a set of business solutions, the program product comprising computer program code for enabling the computer infrastructure to perform the method steps of claim 1.

12. A system for evaluating a set of business solutions, the system comprising:
a system for obtaining the set of business solutions, wherein each of the set of business solutions comprises at least one modification to a set of business concerns for a target enterprise;
a system for obtaining a value model that comprises a value for each of the set of business concerns; and
a system for determining a business value for each of the set of business solutions based on the value model.

13. The system of claim 12, further comprising:
a system for providing the set of business solutions for review; and
a system for prioritizing the set of business solutions based on their corresponding business values.

14. The system of claim 12, further comprising a system for selecting at least one of the set of business solutions for implementation.

15. The system of claim 14, further comprising a system for measuring an actual business value of the selected at least one of the set of business solutions after implementation for the target enterprise.

16. The system of claim 15, further comprising a system for adjusting the value model based on the measured actual business value.

17. The system of claim 12, further comprising a system for obtaining a business model for a target enterprise, wherein the business model includes a set of business concerns.

18. The system of claim 17, wherein the system for obtaining a set of business solutions:
obtains a business pain point for the target enterprise; and
generates the set of business solutions based on the business pain point and the business model.

19. The system of claim 18, wherein the set of business solutions generation includes:
obtaining a set of target business concerns associated with the business pain point;
obtaining a set of shortfalls in the set of target business concerns; and
generating the set of business solutions to address the set of shortfalls.

20. The system of claim 17, wherein the system for obtaining a business model:
selects a business model template based on a type of business; and
adjusts the business model template based on feedback from the target enterprise.

21. A method of managing a set of business solutions, the method comprising:
obtaining a business pain point for a target enterprise;
obtaining a business model for the target enterprise, wherein the business model includes a set of business concerns;
obtaining a value model that comprises a value for each of the set of business concerns;
identifying a set of target business concerns associated with the business pain point based on the business model;
identifying a set of shortfalls in the set of target business concerns;
generating the set of business solutions to address the set of shortfalls; and
determining a business value for each of the set of business solutions based on the value model.

22. The method of claim 21, further comprising:
prioritizing the set of business solutions based on their corresponding business values; and
providing the set of business solutions for review.

23. The method of claim 21, further comprising selecting at least one of the set of business solutions for implementation.

24. The method of claim 21, further comprising implementing at least one of the set of business solutions for the target enterprise.

25. The method of claim 24, further comprising adjusting the business model based on the implemented at least one of the set of business solutions.

26. The method of claim 21, further comprising measuring an actual business value of at least one of the set of business solutions after implementation for the target enterprise.

27. The method of claim 26, further comprising adjusting the value model based on the measured actual business value.

28. A method of generating a system for evaluating a set of business solutions, the method comprising:
providing a computer infrastructure operable to:
obtain the set of business solutions, wherein each of the set of business solutions comprises at least one modification to a set of business concerns for a target enterprise;
obtain a value model that comprises a value for each of the set of business concerns; and
determine a business value for each of the set of business solutions based on the value model.
